(19) United States
(12) Patent Application Publication
(10) Pub. No.: US 2017/0132093 A1
(43) Pub. Date: May 11, 2017

(54) UNDO REDO ACROSS APPLICATION SESSIONS

(71) Applicant: EMC IP Holding Company LLC, Hopkinton, CA (US)

(72) Inventors: Michael John Dutch, Los Gatos, CA (US); Christopher Hercules Claudatos, San Jose, CA (US)

(73) Assignee: EMC IP Holding Company LLC, Hopkinton, MA (US)

(21) Appl. No.: 15/404,493

(22) Filed: Jan. 12, 2017

Related U.S. Application Data
(63) Continuation-in-part of application No. 13/077,780, filed on Mar. 31, 2011, now abandoned.

(51) Int. Cl. G06F 11/14; G06F 17/30

(52) U.S. Cl. CPC G06F 11/1474; G06F 17/30312; G06F 2201/87

(57) ABSTRACT

Data operations occurring on a data during a first application session from the multiple applications sessions are recorded in memory. The data is stored to a non-transitory computer readable storage medium. The data operations are also stored as metadata on the non-transitory computer readable storage medium. Both the data and the metadata are loaded during a second application session from the multiple application sessions. The data is then manipulated using the metadata.

### CROSS REFERENCE TO RELATED APPLICATIONS

This application is a continuation-in-part of co-pending U.S. Patent Application No. 13/077,780 (Attorney Docket No. EMC-11-205), filed Mar. 31, 2011, entitled “AGGREGATE UNDO REDO,” which is incorporated herein by reference for all purposes

### FIELD OF THE INVENTION

This invention relates generally to processing data, and more particularly to performing undo/redo operations across application sessions.

### BACKGROUND OF THE INVENTION

Computer users may interact with an application over a series of sessions. For example, a user may open a word processing application to start a session, interact with a document during the session, and then close the document ending a session. Traditionally, undo/redo operations have been limited to operations a user performs during a given session. Once the session is ended, a user may be unable to undo or redo operations performed during that session. This may limit the utility of the undo/redo operations.

There is a need, therefore, for an improved method, article of manufacture, and apparatus for performing undo/redo operations across application sessions.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram of a life cycle of a dataset in accordance with some embodiments.

FIG. 2 depicts a process for undo/redo across application sessions in accordance with some embodiments.

FIG. 3 is a general purpose computer consistent with some embodiments.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer readable medium such as a computer readable storage medium or a computer network wherein computer program instructions are sent over optical or electronic communication links. Applications may take the form of software executing on a general purpose computer or be hardwired or hard coded in hardware. In this specification, these implementations, or any other form that the invention may take, may be referred to as techniques. In general, the order of the steps of disclosed processes may be altered within the scope of the invention.

An embodiment of the invention will be described with reference to a data storage system in the form of a storage system configured to store files, but it should be understood that the principles of the invention are not limited to this configuration. Rather, they are applicable to any system capable of storing and handling various types of objects, in analog, digital, or other form. Although terms such as document, file, object, etc. may be used by way of example, the principles of the invention are not limited to any particular form of representing and storing data or other information; rather, they are equally applicable to any object capable of representing information.

An application's undo/redo functionality may either undo changes made to data, or to redo changes previously undone. For example, if a user is working in Microsoft Word, and accidentally deletes a paragraph, the user may hit “undo” (e.g. CTRL +Z) to undo the delete. Similarly, redo may be viewed as a user's intention to recover data that was removed by undo. Following the above example, if the user decided that the paragraph actually should be deleted, the user may hit “redo” (e.g. CTRL +Y) to redo the delete.

Undo/redo operations, however, have traditionally been limited to a single application session. Once the session has ended, the user may no longer be able to undo and/or redo any operations. For example, if a user undoes changes in a document, saves the document, and closes the word processing application (thereby ending the session), that user will not be able to redo the changes in a future session. The present disclosure addresses these limitations.

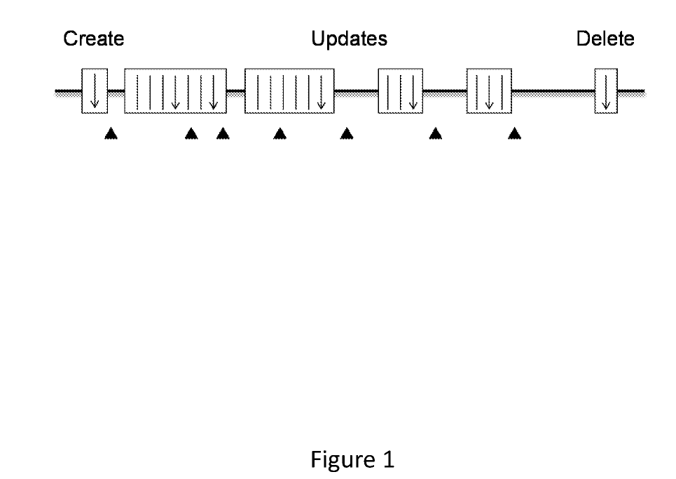

The enhanced techniques described herein enable undo/redo operations across multiple application sessions. FIG. 1 illustrates a dataset life cycle in accordance with some embodiments. The horizontal black line represents time, while each of the rectangles on the line may represent a single application session. During each session, the dataset is manipulated in some manner. Each vertical line represents a data operation occurring on the dataset. This could be, for example, deleting data from the dataset, adding data to the dataset, or updating data already in the set. Arrows within the sessions represent commits to persistent storage, such as a save.

In one example, such as that depicted in FIG. 1, a document may be created in the first session and saved to persistent storage. This document may be substantially empty as no data operations (vertical lines) were performed during the session. At a later time, the document may be opened, starting the second session. Three edits may be made to the document before it is saved a second time at the vertical error. Two more edits may occur before the document is saved a third time and the session is ended.

Black triangles in FIG. 1 may represent different versions of the dataset. A version of the dataset may comprise that dataset's content and any accompanying metadata at a particular point in time. Versions may represent the dataset as it is stored to persistent storage or as it exists in memory, depending on when the version is observed. For example, the first version in FIG. 1 occurs after the dataset is saved, so it represents the data on persistent storage. The second version occurs during the second session, so it may represent the content/metadata as it exists in memory.

Periodically throughout the dataset's life cycle, versions may be created on persistent storage. Versions may be created at set intervals, at a user's request, each time the dataset is saved (i.e. at the arrows), at every data operation (vertical line), and/or at any other time. Once created, a version may be used to facilitate cross-session undo/redo operations.

In some embodiments, undo/redo operations within a single session may operate as they normally would. If a user or system attempts to “undo” past the start of the current session, however, a previous version of the dataset may be identified and loaded. Since that version contains all of the metadata associated with the data operations, undo can continue into the previous session.

For example, in FIG. 1 a user may be modifying a document in the third session. The user may, however, decide to undo revisions back past the start of the third session. The third version of the dataset (third black triangle) was created at the end of the second session. That third version may be loaded, enabling the undo of changes within the second session.

The present disclosure may also enable redo across multiple sessions. A user could, for example, load a version of the dataset that is not the most current. For example, any dataset version depicted in FIG. 1 may be loaded, even if there is a more current version. If a user attempts to redo the data operations, the next most recent version may be loaded and the data operation for the redo may be located in the metadata. For example, a user may load the first version depicted in FIG. 1 for data manipulation, such as editing. Since there were no data operations occurring before the first version other than a create event, this version may be a substantially empty dataset. The user may then attempt to “redo” an operation. As a result, the second version may be loaded and the first data operation occurring after the first version may be identified. That operation may then be applied to the dataset, creating a “redo” operation.

In some embodiments, versions may only contain the delta, or difference, between themselves and the last version that was taken. For example, version 1 may only contain content and metadata from the dataset creation to itself. Version 2, however, may only contain the content and metadata between version 1 and itself. Storing the delta may be beneficial as it reduces the amount duplicate content and/or metadata persistently stored. In some embodiments, content and metadata may be deduplicated separately. For example, metadata may be stored at one location on persistent storage while content is stored at another.

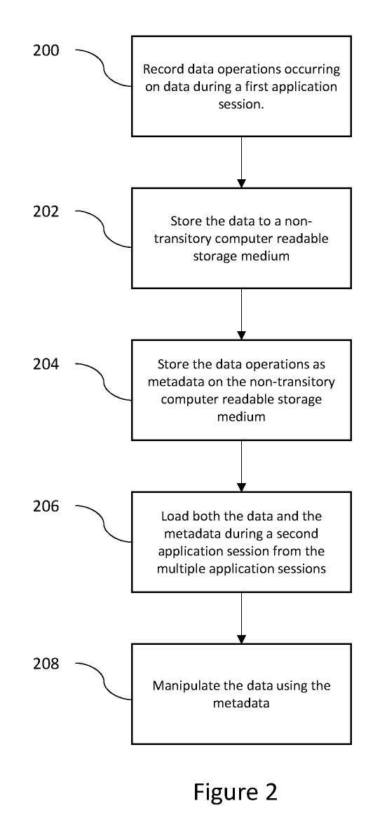

Turning now to FIG. 2, a process for performing undo/redo operations across sessions is discussed. In some embodiments, this process may use versions, as discussed above, to perform the undo/redo operations.

At block 200, data operations occurring during an application session may be recorded. These data operations could be, for example, the vertical lines discussed in FIG. 1. Data operations may include any operations used to manipulate the dataset.

At block 202, the dataset may be stored on a non-transitory computer readable medium. This could be, for example, spinning disk or a solid state drive. In some embodiments, storing the dataset to disk may comprise storing data content as part of a version. Additionally or alternatively, it may be a standard commit of the data, such as when a user saves a document.

At block 204, data operations occurring during the session may also be saved to the persistent storage as metadata. These data operations could be, for example, the vertical black lines depicted in FIG. 1. In some embodiments, only data operations occurring since a previous data operation save may be stored (such as when two versions are created within the same session). Additionally or alternatively, all of the data operations occurring within a single session may be saved.

In some embodiments, the stored metadata may also be part of a saved version. The metadata may be stored either with the dataset content, or separately from it. Metadata may also include more than just data operations. For example, it may include information about which user performed the operations. This may enable another user to undo/redo that user's changes, and/or prevent a user from undo/redoing another user's changes. It may also be used to create an audit of changes a given user made to a document. Additionally or alternatively, the metadata may include security settings as they existed at a particular point in time. This may enable those security settings, such as user access, to be undone/redone like the data content. Metadata may also include timestamps, and/or customizable tags, such as a character string.

In some embodiments, the stored data and stored metadata together may comprise a version. At block 206, the version may be loaded during a second session. This could be, for example, a session occurring at a later point. The version may be restored as the result of a user performing an undo operation past the start of the second session, or as the result of a user trying to redo data past their current version.

Finally, at block 208, the data may be manipulated using the metadata. This could include, for example, redoing data operations and/or undoing data operations.

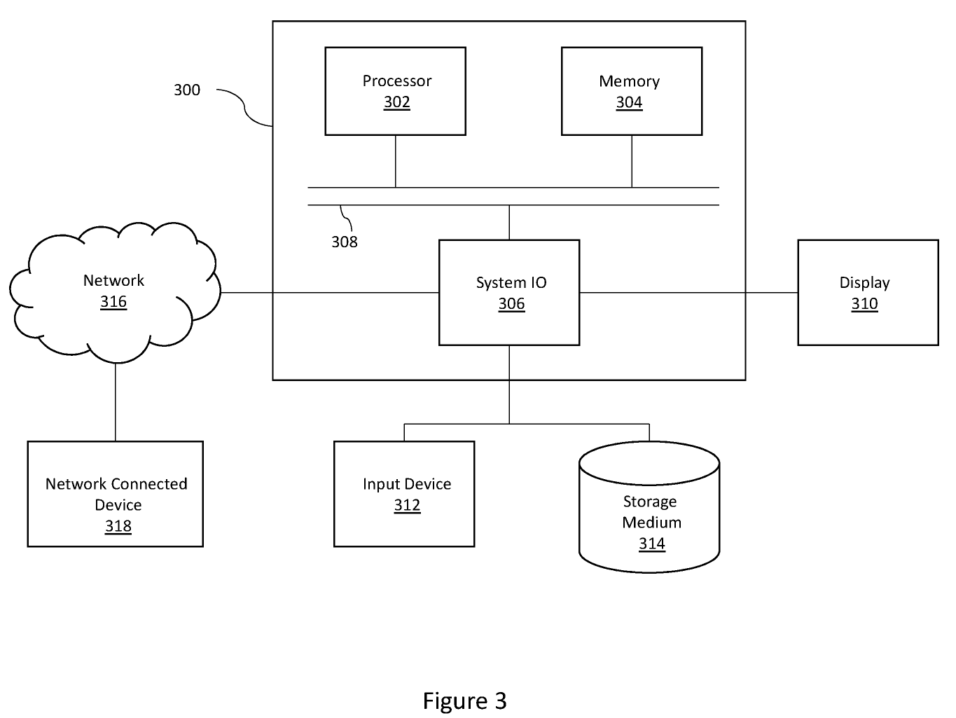

FIG. 3 depicts a computer system which may be used to implement different embodiments discussed herein. General-purpose computer 300 may include processor 302, memory 304, and system IO controller 306, all of which may be in communication over system bus 308. In an embodiment, processor 302 may be a central processing unit (“CPU”) or accelerated processing unit (“APU”). Some embodiments may comprise multiple processors, or a processor with multiple cores. Processor 302 and memory 304 may together execute a computer process, such as the processes described herein.

System IO controller 306 may be in communication with display 310, input device 312, non-transitory computer readable storage medium 314, and/or network 316. Display 310 may be any computer display, such as a monitor, a smart phone screen, or wearable electronics and/or it may be an input device such as a touch screen. Input device 312 may be a keyboard, mouse, track-pad, camera, microphone, or the like, and storage medium 314 may comprise a hard drive, flash drive, solid state drive, magnetic tape, magnetic disk, optical disk, or any other computer readable and/or writable medium. Storage device 314 may also reside inside general purpose computer 300, rather than outside as shown in FIG. 1.

Network 316 may be any computer network, such as a local area network (“LAN”), wide area network (“WAN”) such as the internet, a corporate intranet, a metropolitan area network (“MAN”), a storage area network (“SAN”), a cellular network, a personal area network (PAN), or any combination thereof. Further, network 316 may be either wired or wireless or any combination thereof, and may provide input to or receive output from IO controller 306. In an embodiment, network 316 may be in communication with one or more network connected devices 318, such as another general purpose computer, smart phone, PDA, storage device, tablet computer, or any other device capable of connecting to a network.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The disclosed embodiments are illustrative and not restrictive, and the invention is not to be limited to the details given herein. There are many alternative ways of implementing the invention. It is therefore intended that the disclosure and following claims be interpreted as covering all such alterations and modifications as fall within the true spirit and scope of the invention.

What is claimed is:

1. A method for performing undo/redo operations across multiple application sessions, the method comprising:
recording, in a memory, data operations occurring on a data during a first application session from the multiple applications sessions;
storing the data to a non-transitory computer readable storage medium;
storing the data operations as metadata on the non-transitory computer readable storage medium;
loading both the data and the metadata during a second application session from the multiple application sessions; and
manipulating the data using the metadata.

2. The method of claim 1, wherein manipulating the data comprises undoing at least one of the data operations from the first application session.

3. The method of claim 1, wherein manipulating the data comprises redoing at least one of the data operations from the first application session.

4. The method of claim 1, wherein the data and the metadata are stored in separate logical locations.

5. A system for performing undo/redo operations across multiple application sessions, the system comprising a non-transitory computer readable storage medium and a processor executing instructions for:
recording, in a memory, data operations occurring on a data during a first application session from the multiple applications sessions;
storing the data to a non-transitory computer readable storage medium;
storing the data operations as metadata on the non-transitory computer readable storage medium;
loading both the data and the metadata during a second application session from the multiple application sessions; and
manipulating the data using the metadata.

6. The system of claim 5, wherein manipulating the data comprises undoing at least one of the data operations from the first application session.

7. The system of claim 5, wherein manipulating the data comprises redoing at least one of the data operations from the first application session.

8. The system of claim 5, wherein the data and the metadata are stored in separate logical locations.

9. A computer program product for performing undo/redo operations across multiple application sessions, the computer program product comprising a non-transitory computer readable medium encoded with computer executable program, the code enabling:
recording, in a memory, data operations occurring on a data during a first application session from the multiple applications sessions;
storing the data to a non-transitory computer readable storage medium;
storing the data operations as metadata on the non-transitory computer readable storage medium;
loading both the data and the metadata during a second application session from the multiple application sessions; and
manipulating the data using the metadata.

10. The method of claim 9, wherein manipulating the data comprises undoing at least one of the data operations from the first application session.

11. The method of claim 9, wherein manipulating the data comprises redoing at least one of the data operations from the first application session.

12. The method of claim 9, wherein the data and the metadata are stored in separate logical locations.
